(19) United States
(12) Patent Application Publication
(10) Pub. No.: US 2009/0266302 A1
(43) Pub. Date: Oct. 29, 2009

(54) LIQUID CONTAINER FOR ANIMALS

(76) Inventors: John Andrew Duval, Long Beach, CA (US); Le Bui, Tustin, CA (US); David Hedden, Long Beach, CA (US); Jacob Moore, Huntington Beach, CA (US); Charles Van Eessel, Topanga, CA (US)

Correspondence Address: FULBRIGHT AND JAWORSKI LLP, 555 S. FLOWER STREET, 41ST FLOOR, LOS ANGELES, CA, 90071, US

(21) Appl. No.: 12/111,809

(22) Filed: Apr. 29, 2008

(51) Int. Cl. A01K 7/00

(52) U.S. Cl. 119/72; 248/228.7

(57) ABSTRACT

A drinking bowl includes a container for holding liquid and a buoyant member connected to the inside of the container for covering a liquid in the container. The buoyant member has an opening for access to liquid in the container, and is hingedly connected to the inside of the container such that the buoyant member can move, when liquid is in the container, between a position of floating in the liquid and a position of resting on the bottom of the container. In further embodiments, a mounting bracket is included with the drinking bowl, for attaching the drinking bowl to a support.

### BACKGROUND

1. Field of Invention

This invention relates generally to a drinking bowl for animals.

### RELATED ART

Dogs and other small animals are typically transported by plane and automobile in collapsible or dismantleable cages. Examples of such cages include hard-sided transporters having heavy-duty plastic shells and wire doors, fold-down wire mesh transporters, and soft-sided transporters having tubular frames with soft, flexible shells. To provide water and other liquids for transported animals, various water bowls or dishes are available for use with transporters. In general, these containers are simple bowls that can be attached to the inside of transporters using clips, hooks or clamps. Some containers are equipped with covers to reduce spilling and splashing while still allowing access to the enclosed liquid. However, spillage and splashing continue to be problems when liquid is added beyond a minimal level, or when containers are tipped at an angle, such as during passage through an airport baggage handling system, or going up and down an incline.

### SUMMARY

In one aspect, the present invention provides a drinking bowl. The drinking bowl includes a container for holding liquid, the container having a closed bottom, a sidewall connected to the closed bottom, and an open top defined by the sidewall. The drinking bowl includes a buoyant member placed within the container for covering liquid in the container. The buoyant member is hingedly connected to the sidewall and moveable, when liquid is in the container, between a position of floating in the liquid and a position of resting on the container bottom. In addition, the buoyant member has at least one opening for access to liquid in the container. The drinking bowl can provide for reduced spilling, splashing, or both, thus conserving liquid, increasing liquid availability, and reducing the number of times the bowl is refilled. Further, in various embodiments, the drinking bowl can be tipped at an acute angle with spilling and/or splashing kept to a minimum.

In another aspect, the present invention provides a mounting bracket for attaching a drinking bowl to a support such as a wire mesh door, a wire mesh sidewall, or a tubular frame. In one embodiment, the mounting bracket is a spring-loaded clamping device that includes front, middle and back plates. The front plate has a raised region and an opening, and the back plate is connected to the front plate in face-to-face orientation. The middle plate is sandwiched between the front plate and the back plate, which allows the middle plate to move back and forth between the front and back plates. The middle plate includes a raised region which passes through the front plate opening to align with the raised region of the front plate. The raised regions of the front and middle plates cooperate to form a clamp for holding the support. A spring is connected to the middle plate and the front or back plate to provide tension for closing the clamp as the middle plate moves back and forth between the front and back plates. The mounting bracket also includes a means for attaching the bracket to a drinking bowl.

In another embodiment, the mounting bracket is a retaining clip. The retaining clip includes a front plate having means for attachment to a drinking bowl, and a retainer plate that connects the front plate to a support. The front plate includes a latch for holding and releasing the drinking bowl.

In further aspects, the present invention provides a drinking bowl assembly. The assembly includes a drinking bowl of the present invention, and a mounting bracket for attaching the drinking bowl to the transporter. In some embodiments, the mounting bracket is a spring-loaded clamping device or a retaining clip.

In various embodiments, the configuration of the drinking bowl and its parts is such that, relative to the size of the drinking bowl, a large volume of liquid can be held with little or no spilling and/or splashing of the liquid. By holding a large liquid volume, and reducing spilling and/or splashing, the drinking bowl can provide liquid over an extended period of time without refilling. This contrasts with conventional drinking bowls used in animal transporters, which involve more frequent refilling due to spillage, splashing and the relatively small volume of liquid held.

The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF DRAWINGS

FIG. 1 is an exploded perspective view of a drinking bowl;

FIG. 2A-C are cross-sectional views of a drinking bowl at various liquid levels;

FIG. 3 is a top view and close-up view of a buoyant member in a container;

FIG. 4 is a perspective view of the underside of a buoyant member;

FIG. 5 is a perspective view of a spring-loaded clamping device;

FIG. 6 is an exploded perspective view of a spring-loaded clamping device;

FIG. 7A-B are a front plan view and a sectional view of a spring-loaded clamping device;

FIG. 8 is another exploded perspective view of a spring-loaded clamping device;

FIG. 9 is a FIG. 9 is a cross-sectional view of a spring-loaded clamping device;

FIG. 10 is a perspective view of the underside of a drinking bowl;

FIG. 11 is a bottom plan view of the container attached to a mounting bracket;

FIG. 12 is a perspective view of a drinking bowl attached to a support by a mounting bracket;

FIG. 13 is a front perspective view of a retaining clip;

FIG. 14 is a perspective view of a drinking bowl assembly, including a two-piece retaining clip;

FIG. 15 is a cross-sectional view of a drinking bowl connected to a two-piece retaining clip;

FIG. 16 is a perspective view of a drinking bowl attached to a wire mesh by a two-piece retaining clip;

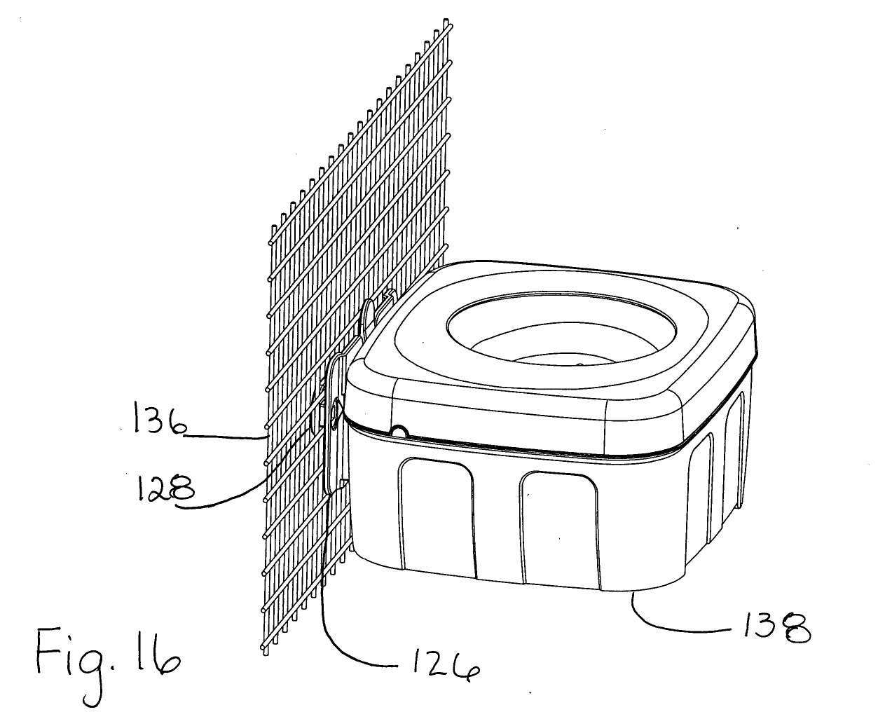

FIG. 17 is a cross-sectional view of a drinking bowl and lid; and

FIG. 18 is a perspective view of the underside of a lid.

### DETAILED DESCRIPTION

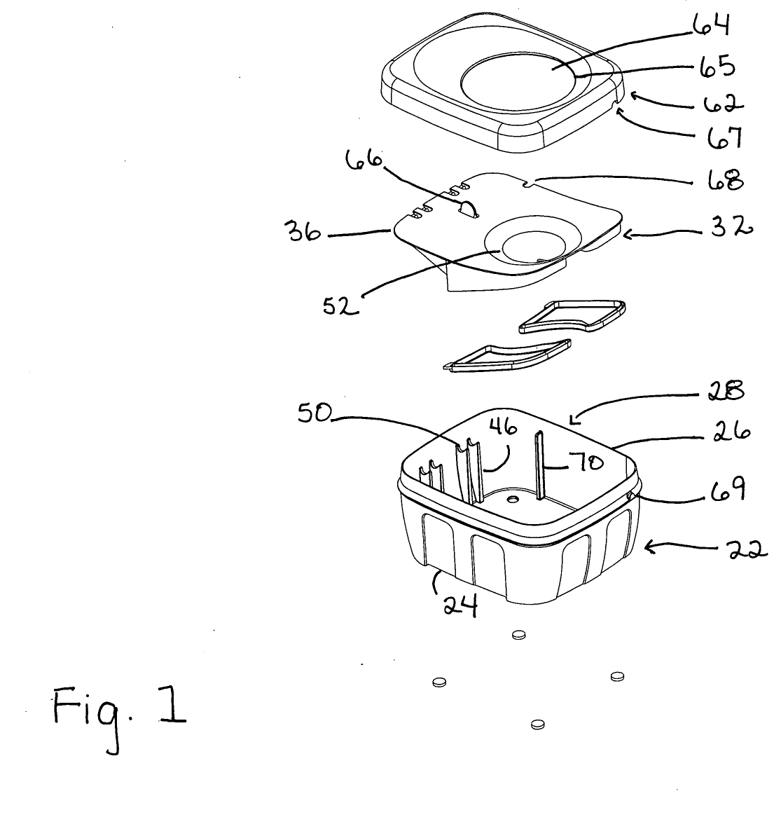

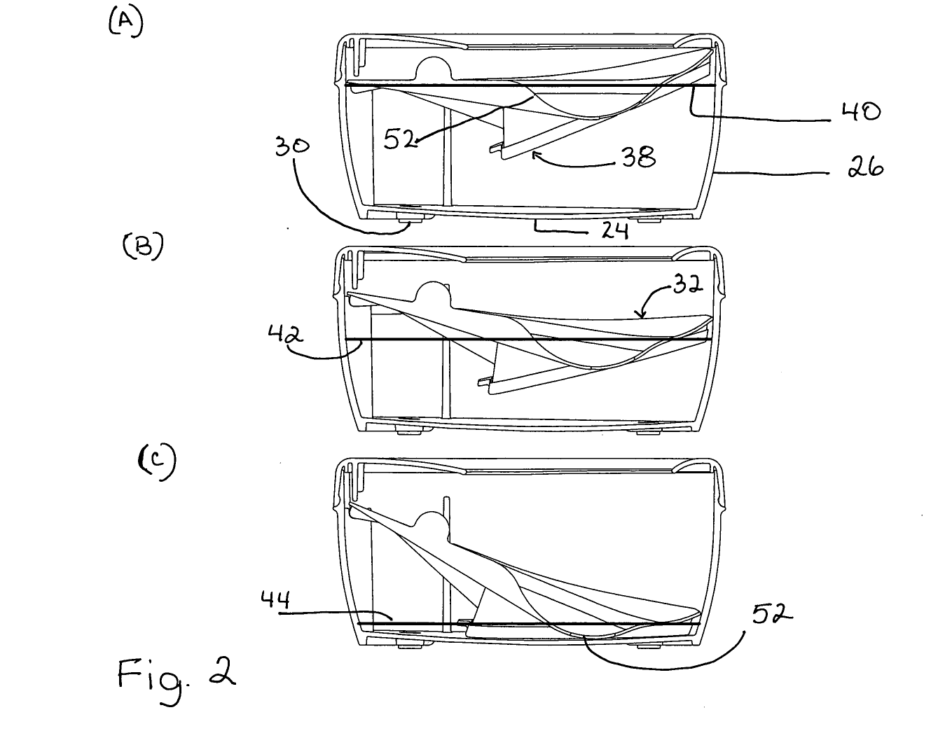

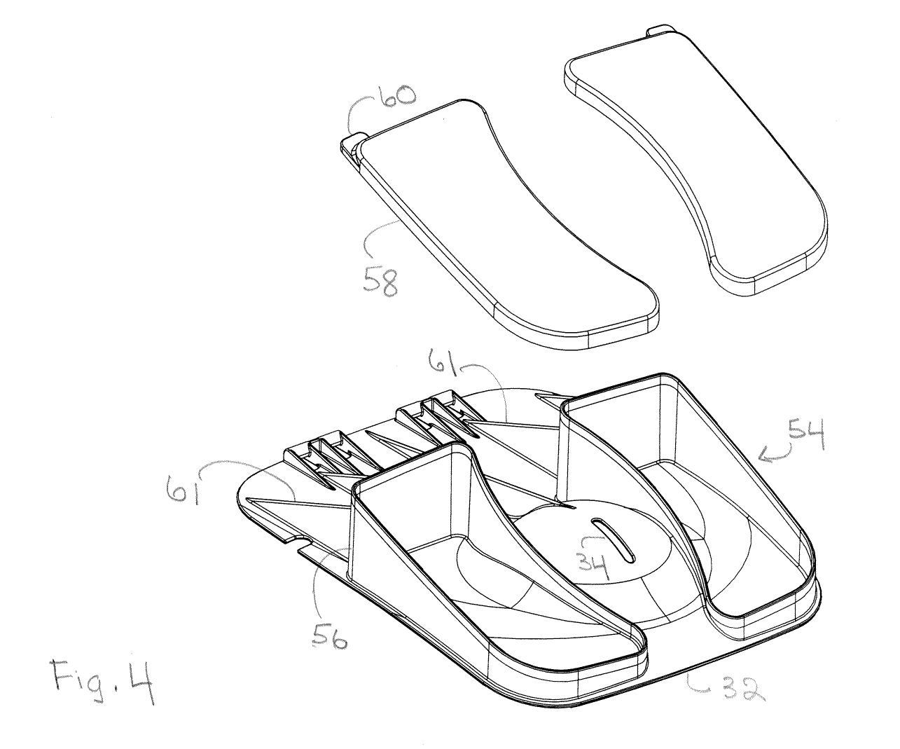

Referring to FIGS. 1 and 2 showing an embodiment of a drinking bowl for use with an animal transporter, the drinking bowl comprises a container 22 having a closed bottom 24, a sidewall 26 connected to the closed bottom, and an open top 28 defined by the sidewall 26. Feet 30, which can be pads, discs, knobs and the like, can be located under the container bottom for support. In some embodiments, the feet are made of non-slip material. Hingedly connected to the sidewall is a buoyant member 32 having an opening 34 (see FIG. 4) providing access to a liquid in the container, such as water, milk or another beverage. The buoyant member 32 includes a surface portion 36 and a float portion 38. The connection of the buoyant member 32 to the sidewall 26 by a hinge mechanism allows the buoyant member 32 to move in a pivoting manner between a position where the buoyant member 32 is floating in the liquid, as shown in FIG. 2A, and a position where the buoyant member 32 is resting on the bottom of the container, as shown in FIG. 2C. Depending on such conditions as the size and shape of the container 22, and the configuration of the buoyant member 32, the buoyant member 32 can float in the liquid at various liquid levels 40 and 42 in the container 22. However, at a certain liquid level 44, the liquid will not be enough to support floating and the buoyant member 32 will rest on the bottom of the container 22. In such position, the liquid can still be accessible. Thus, in various embodiments, an animal can drink substantially all of the liquid in the container.

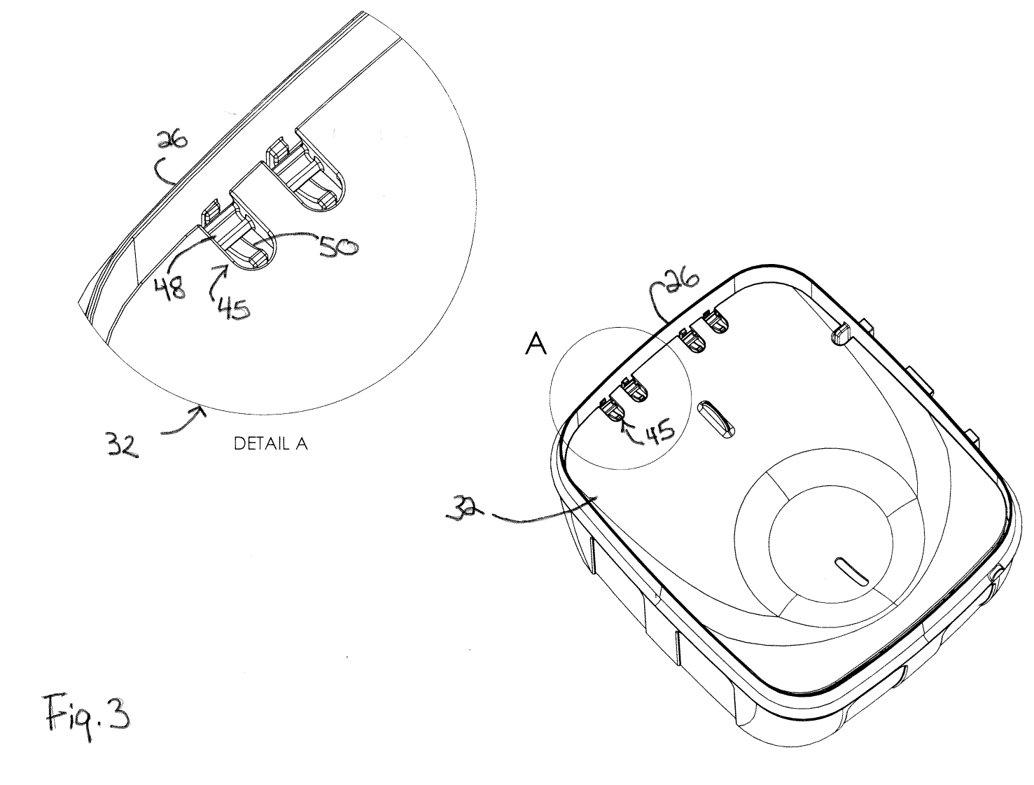

Referring to FIGS. 1 and 3, the buoyant member 32 is connected to the sidewall 26 by a hinge mechanism 45 that includes a hinge support 46 attached to the sidewall 26 of the container 22, and a hinge pin 48 attached near the edge of the surface portion 36 of the buoyant member 32. The hinge pin 48 rests in the curved upper surface 50, or cradle, of the hinge support 46, and rotates or pivots in the cradle 50 as the buoyant member 32 moves in accordance with the liquid level. In this embodiment, the cradle 50 is shaped such that the buoyant member 32 can be removed from the container 22 without breaking the hinge pin 48, the cradle 50 or other parts of the hinge mechanism 45. Although four hinge mechanisms are shown in the embodiment of FIG. 3, the number of hinge mechanisms can vary as long as the buoyant member 32 can move in a pivoting manner in relation to the liquid level. Thus, in other embodiments, one, two, three, four, or more than four hinge mechanisms can be utilized. In addition, while a pin and cradle hinge mechanism is shown, any other hinge known in the art can be used as long as the buoyant member 32 can move in a pivoting manner in relation to the liquid level.

As shown in FIGS. 1, 2 and 4, the surface portion 36 of the buoyant member 32 includes a depressed region 52 having an opening 34 that allows access to the liquid. The surface portion 36 is configured so that the opening 34 is below the level of the liquid at substantially all liquid levels in the container 22. Thus, an animal can drink from the bowl even when minimal liquid remains in the container. Other embodiments can contain two or more openings in the depressed region, or two or more depressed regions in the surface portion of the buoyant member.

In further embodiments, the surface portion 36 and the buoyant member 32 as a whole are configured such that the opening allowing access to the liquid is above the liquid surface at substantially all liquid levels. In these embodiments, an animal pushes the buoyant member 32 downward and into the liquid in order to drink.

Referring to FIG. 4 showing the underside of the buoyant member 32, in one embodiment, the float portion 38 of the buoyant member 32 comprises two float elements 54 providing buoyancy to the float portion 38. Each float element 54 includes a float body 56 and a float base 58, which in this case is removeable in a reversible manner. Tab 60 is included for convenient removal of the float base 58. In this embodiment, splines 61 are added to the underside of the buoyant member 32 for support. The opening 34 in the buoyant member 32 providing access to a liquid in the container is also shown in this figure.

Although in this embodiment each float element 54 is hollow, in other embodiments, the float element 54 can be filled with a material having a density less than water, such as a polyurethane blend, cork, or other materials known in the art, or having a density greater than water, so long as the buoyant member can float in the liquid and rest on the bottom of the container.

In some embodiments, the drinking bowl is equipped with a lid 62 as shown in FIG. 1. The lid 62 covers the container 22 and the buoyant member 32, providing increased stability to the drinking bowl and added containment for any liquid in the container 22 or on the surface of the buoyant member 32. The lid 62 has an opening 64 that is preferably aligned with the opening 34 of the buoyant member 32, thus allowing ready access to liquid in the container. In some embodiments, the opening 64 has an edge 65 that is turned slightly downward, which helps to reduce liquid spilling and/or splashing.

Preferably, the drinking bowl can be disassembled into its container 22, buoyant member 32 and lid 62 parts. This allows for cleaning or replacement of the various parts of the drinking bowl.

In the embodiment shown in FIG. 1, the buoyant member 32 includes a handle 66 that can be used to insert the buoyant member 32 into the container 22 and onto the container hinge supports 46, and to remove the buoyant member 32. The buoyant member also includes an orienting notch 68 which aligns with an orienting rib 70 in the container 22 to ensure proper alignment of the container 22 and the buoyant member 32.

Although the container shown in FIG. 1 is roughly cuboid in shape, with a substantially rectangular cross section having round corners (the cross section taken parallel to the container bottom), the container can be any shape that allows the buoyant member to float in the liquid and rest on the bottom of the container. For example, the container cross-section can be substantially oval shaped, circular shaped, or square shaped with round corners. Corresponding changes to the shape of the buoyant member and the lid can also be made as long as the buoyant member can float in the liquid and rest on the bottom of the container, and the lid can fit on or over the container. Further, the lid is shown separate from the container, but in other embodiments, the lid can be connected to the container by, for example, a hinge, which allows the lid to pivot onto and off the container.

Similarly, the surface portion and float portion of the buoyant member can be shaped differently from those shown in FIGS. 1 and 2 as long as the buoyant member can float in the liquid and rest on the bottom of the container. For example, the float portion can contain a single float element, three float elements, or more than three float elements. In addition, while the float elements in the figures include a removeable float base, in other embodiments the float base can be permanently attached to the float body.

In preferred embodiments, the surface portion of the buoyant member is sized and shaped to fit snuggly in the container such that liquid in the container is prevented from spilling and/or splashing out between the sidewall and the edges of the surface portion. At the same time, the buoyant member can still move between a floating position and a position of resting on the bottom of the container. In this way, the close fit between the sidewall and edges of the surface portion prevents, reduces or minimizes liquid spilling and/or splashing. For example, some embodiments have little or no spilling and/or splashing of liquid even when the drinking bowl is filled to full capacity and tilted at a 20° angle relative to horizontal. When the drinking bowl is filled to less than full capacity, some embodiments can be tilted at a greater than 20° angle relative to horizontal without spilling and/or splashing. Although a close fit is preferred, in other embodiments the buoyant member can be sized and shaped to fit less closely such that liquid can pass between the sidewall and the edges of the surface portion.

By including a buoyant member with a fit that reduces or minimizes spilling and/or splashing, and by incorporating features such as a lid and a lid opening having a downwardly turned edge, various embodiments of the drinking bowl can hold large volumes of liquid, relative to the size of the drinking bowl, with little or no spilling and/or splashing of the liquid. Thus, more liquid can remain in the bowl for a longer period of time before the bowl is refilled. This can be advantageous, such as when the bowl is used on long trips.

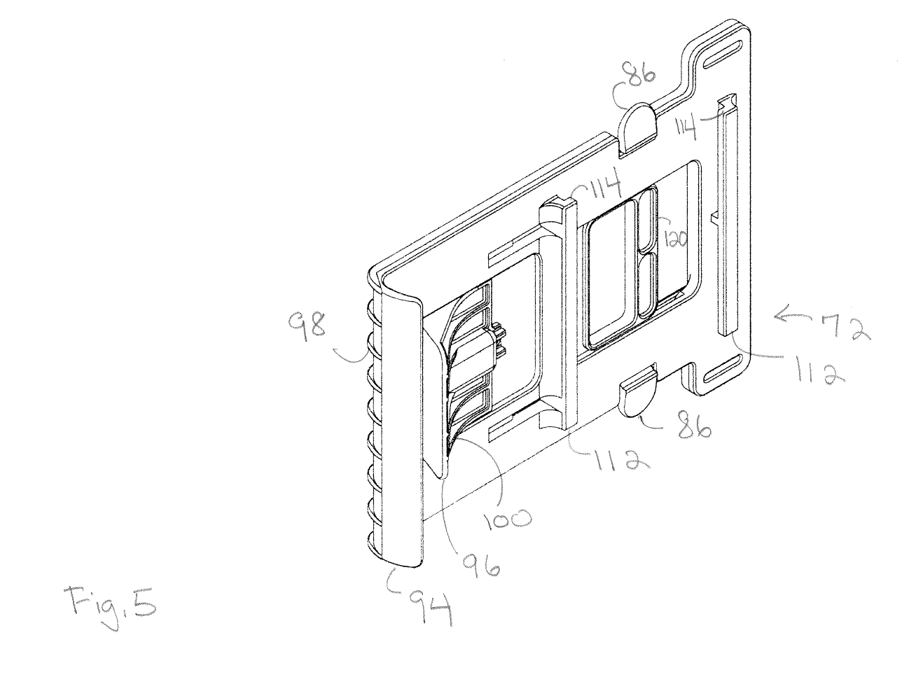

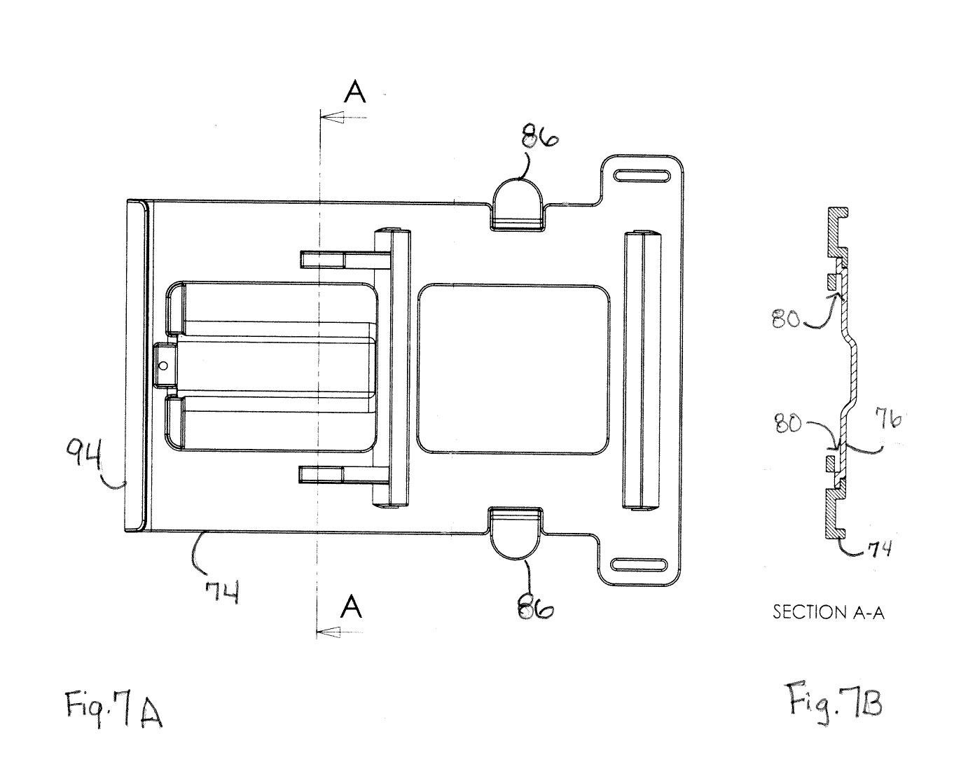

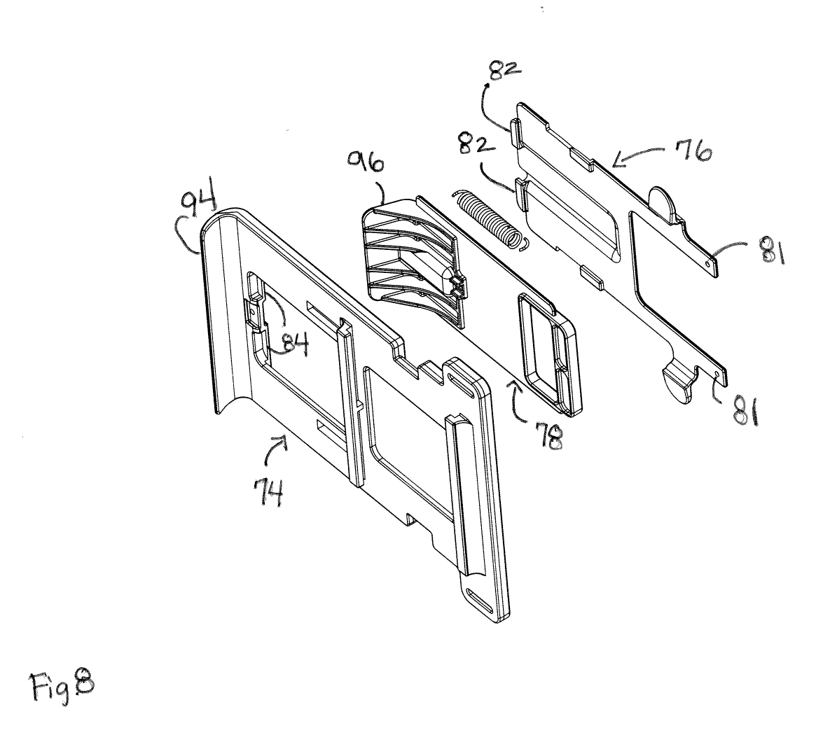

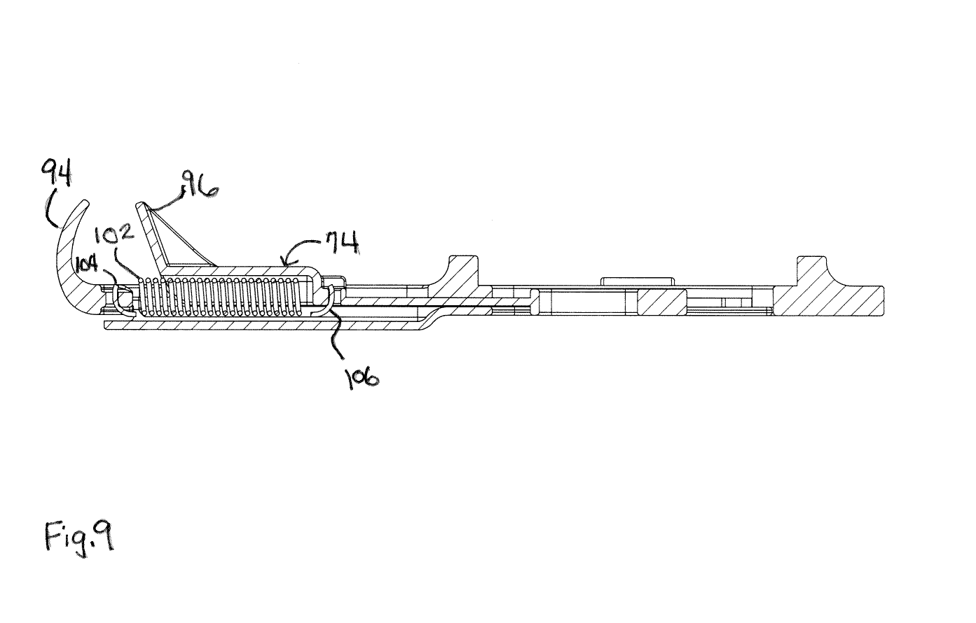

In further embodiments, a mounting bracket is provided for attaching the drinking bowl to a support, such as a wire mesh or a tubular frame of an animal transporter. Referring to FIGS. 5, 6, 7A, 7B, 8 and 9, in some embodiments, the mounting bracket is a spring-loaded clamping device 72. The clamping device 72 includes a front plate 74, a back plate 76, and a middle plate 78 sandwiched between the front and back plates. The front and back plates 74,76 are attached together face-to-face to form a pair of opposed channels 80 running parallel to the length of the front plate. The opposed channels 80 are shown in FIG. 7B, which is a cross-sectional view of the front and back plates 74,76, without the middle plate 78, taken along line A-A. The front and back plates 74,76 can be held together with screws, rivets, bolts, or the like, which fit through holes 81 on the back plate 76 and into the front plate 74. Forward tabs 82 on the back plate fit into slots 84 on the front plate 74, and lateral tabs 86 on the back plate 76 fit into notches 88 on the front plate 74, to attach the plates together. Two peripheral edge regions 90 of the middle plate 78 insert into the pair of opposed channels 80, which allows the middle plate to slide back and forth along the channels and between the front and back plates.

The front plate 74 includes a roughly rectangularly shaped opening 92 adjacent to a raised, curved end region 94. The opening 92 provides access for a raised end region 96 of the middle plate to align with the raised, curved end region 94 of the front plate 74. In this arrangement, the raised end regions can cooperate to form a set of clamping jaws. Splines 98 on the curved end region 94 of the front plate 74 and splines 100 on the raised end region 96 of the middle plate 78 are included for structural support. A coil spring 102 providing tension for clamping has one end 104 attached to the front plate 74 and the other end 106 attached to the middle plate 78. In other embodiments, the spring can attach to the back plate 76 and the middle plate 78. A slot 108 in the back plate 76 and a corresponding slot 110 in the middle plate 78 form a housing for the spring 102.

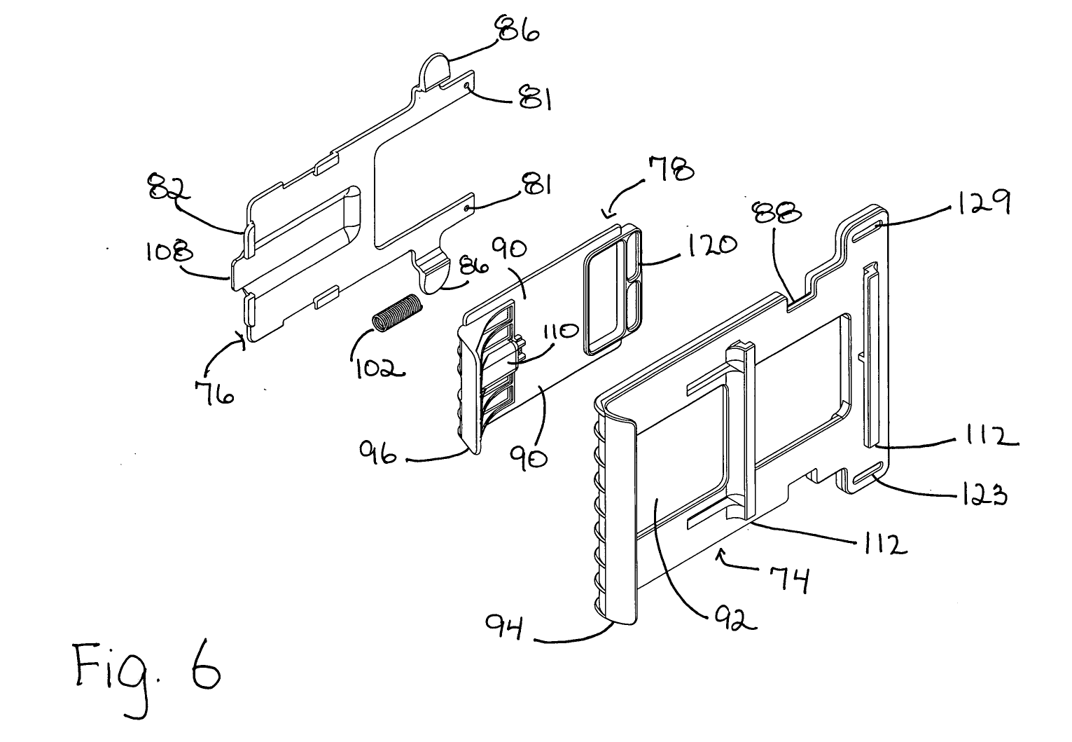

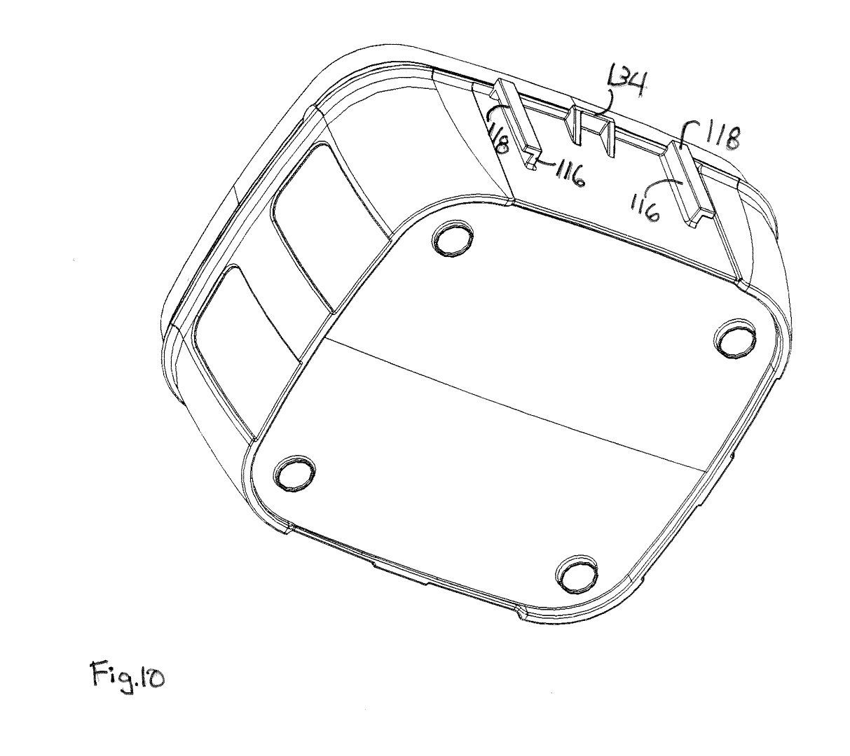

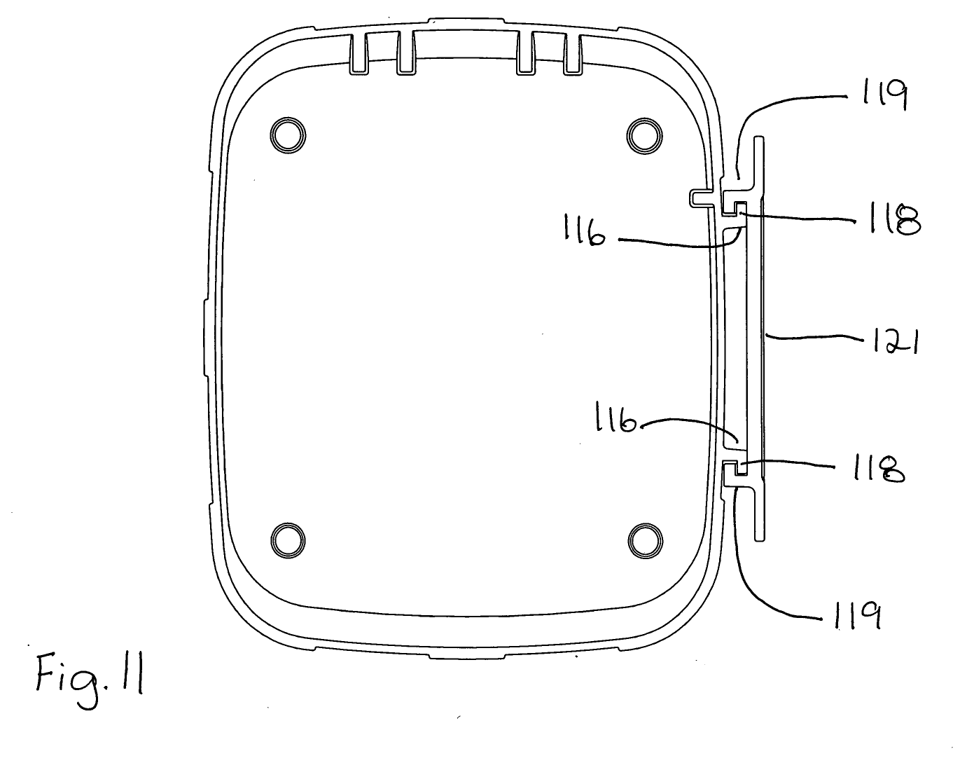

A means for attaching the mounting bracket to the drinking bowl is provided. In the embodiment shown in FIGS. 5 and 6, the means for attachment is a pair of opposed rails 112, each having an extended flange 114. This structure is matched by a complementary structure on the drinking bowl. Thus, attachment of the mounting bracket to the drinking bowl involves a portion of the mounting bracket and a portion of the drinking bowl. In the embodiment shown in FIGS. 10 and 11, the complementary mechanism includes a pair of opposed rails 116, each having an extended flange 118, which fits inside the opposed rails 119 of the mounting bracket 121. As shown in the bottom view of FIG. 11, when connected, the flanges of the mounting bracket 121 mesh with the flanges 118 of the drinking bowl. In other embodiments, any attaching device that involves complementary parts on the mounting bracket and the drinking bowl, such as a knob inserted into a hole, or a hook and eye combination, can be used as long as the attaching device is strong enough to support the drinking bowl and any contained liquid. In addition, other means for attaching the mounting bracket to the drinking bowl are contemplated. Examples of such means include, but are not limited to, adhesive, tape, Velcro, screws and other connectors. Again, any means of attachment can be used as long as the attachment is strong enough to support the drinking bowl and any contained liquid.

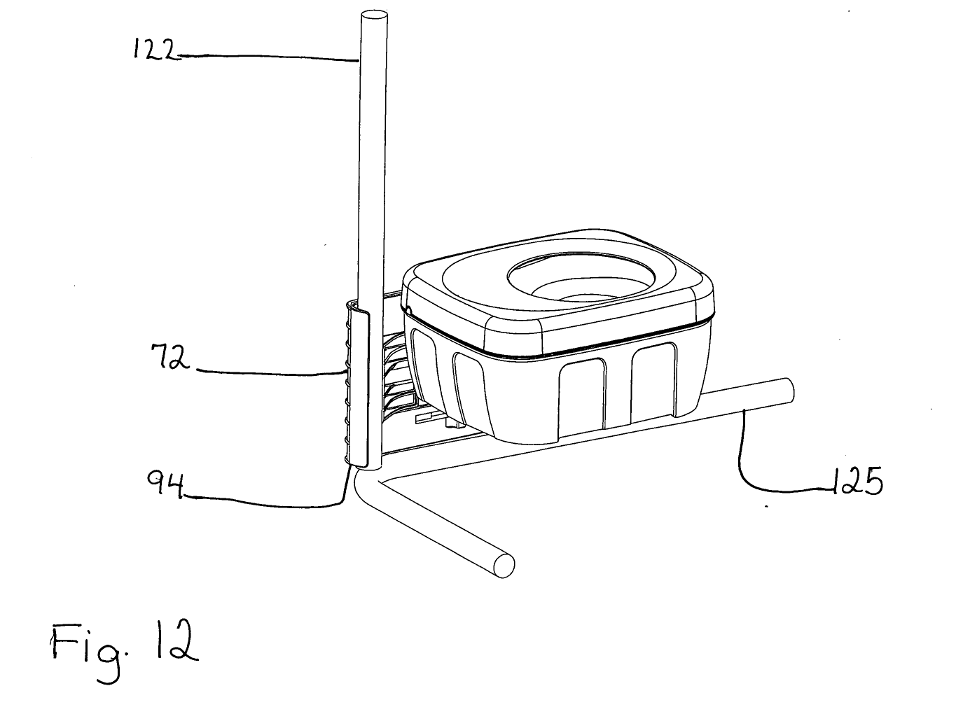

To use the embodiment shown in FIGS. 5 and 6, the raised end region 96 of the middle plate 78 is moved away from the curved end region 94 of the front plate 74 by sliding the middle plate 78 backward, thus opening the clamping jaws. A handle 120 formed in the middle plate 78 provides leverage for sliding. As shown in FIG. 12, the curved end region 94 is fitted around a tubular support 122, which can be a tubular frame member of an animal transporter, and the middle plate 78 is moved forward, bringing the raised end region 96 in contact with the tubular frame member and closing the clamping jaws. The tubular support can be of any cross-sectional shape, such as circular, square or hexagonal. Although the curved and raised end regions 94,96 are shown fitted around a tubular support having a circular cross section, the same end regions can be fitted around tubular supports of any cross sectional shape such as square or hexagonal. In addition, in other embodiments of the mounting bracket, one or both end regions can be configured to more closely match a non-circular cross-section of a tubular support.

End tabs 129,123 shown in FIG. 6 can be placed between a tubular support and a side wall of an animal transporter to provide added support and stability for the drinking bowl. For example, in FIG. 12, end tab 123 would be located between horizontal tubular frame member 125 and a vertical side of the transporter located behind the mounting bracket 72. In addition, an opening is provided in the end tabs 129,123 for optionally adding a Velcro strap or other connecting material therethrough. The added Velcro strap or connecting material can be wrapped around the horizontal tubular frame member 125 for added support and stability.

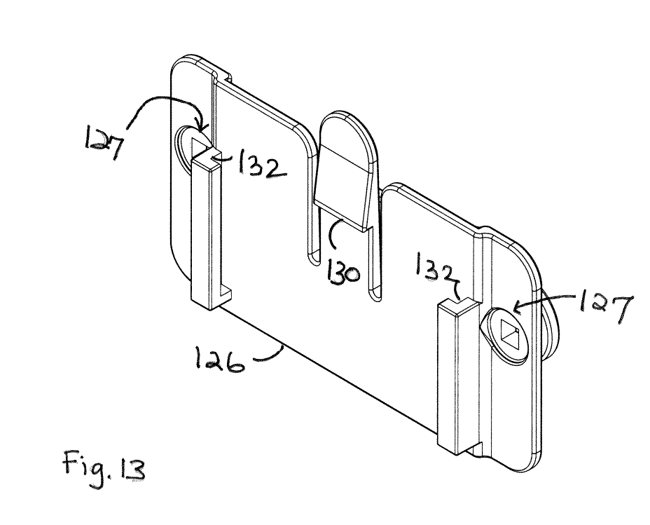

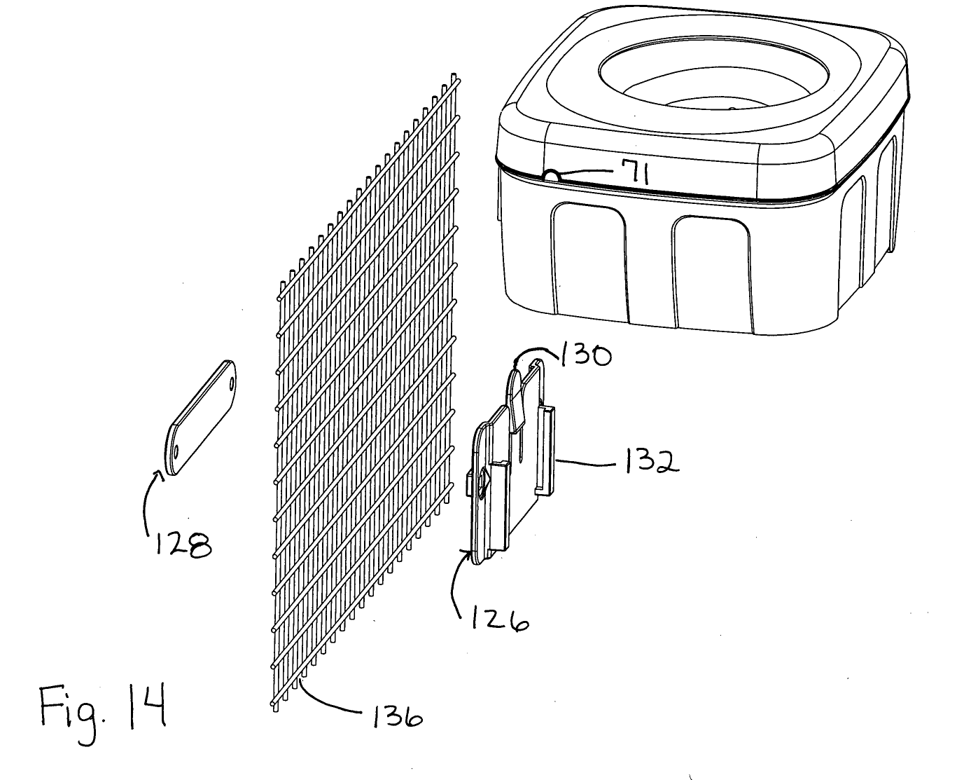

In another embodiment shown in FIGS. 13 and 14, the mounting bracket is a two-piece retaining clip 124 that includes a front plate 126 having means for attachment to a drinking bowl, and a retainer plate 128 for connecting to the front plate to hold the front plate to a support. The front plate 126 and retainer plate 128 can be held together with screws, or the like, such as the fastener 127 shown in FIG. 13.

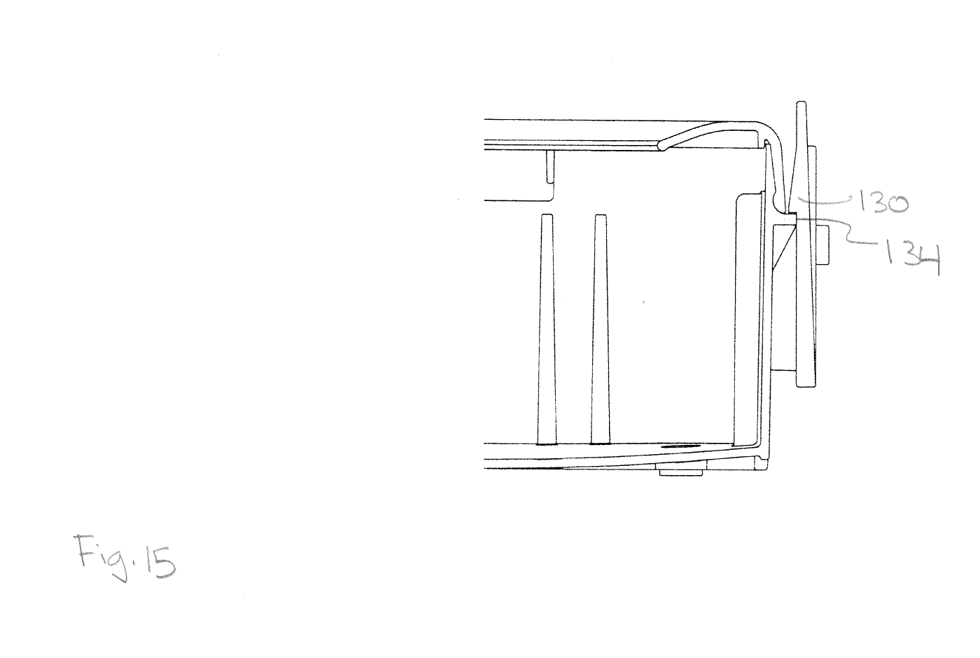

The front plate 126 includes a latch 130 for holding and releasing the drinking bowl. In this embodiment, the front plate 126 includes opposed rails 132 with extended flanges, as in the spring-loaded clamping device described herein, for attachment to the drinking bowl. Similarly, the drinking bowl has a complementary mechanism containing a pair of opposed rails with extended flanges that mesh with the extended flanges of the mounting bracket. Referring to FIGS. 10 and 15, the drinking bowl includes a latch stop 134 for supporting the latch 130. The latch 130 fits over the latch stop 134, preventing the bowl from being unwantedly removed from the retaining clip 124. In some embodiments, the latch 130 can flex in a direction perpendicular to the plane of the front plate 126. This allows the latch 130 to be flexed away from the latch stop 134 when connecting or disconnecting the drinking bowl and the retaining clip 124, and to snap in place over the latch stop 130.

Similarly, in the embodiment of the mounting bracket shown in FIG. 5, each tab 86 can act as a latch that prevents a drinking bowl from being unwantedly removed from the mounting bracket. Again, in various embodiments, the tab 86 can flex away from the latch stop of a drinking bowl when connecting or disconnecting the drinking bowl and the mounting bracket, and can snap in place over the latch stop.

As shown in FIG. 14, the front plate 126 can be attached to a wire mesh 136, or other support, by the retainer plate 128 to hold a drinking bowl 138 to the wire mesh.

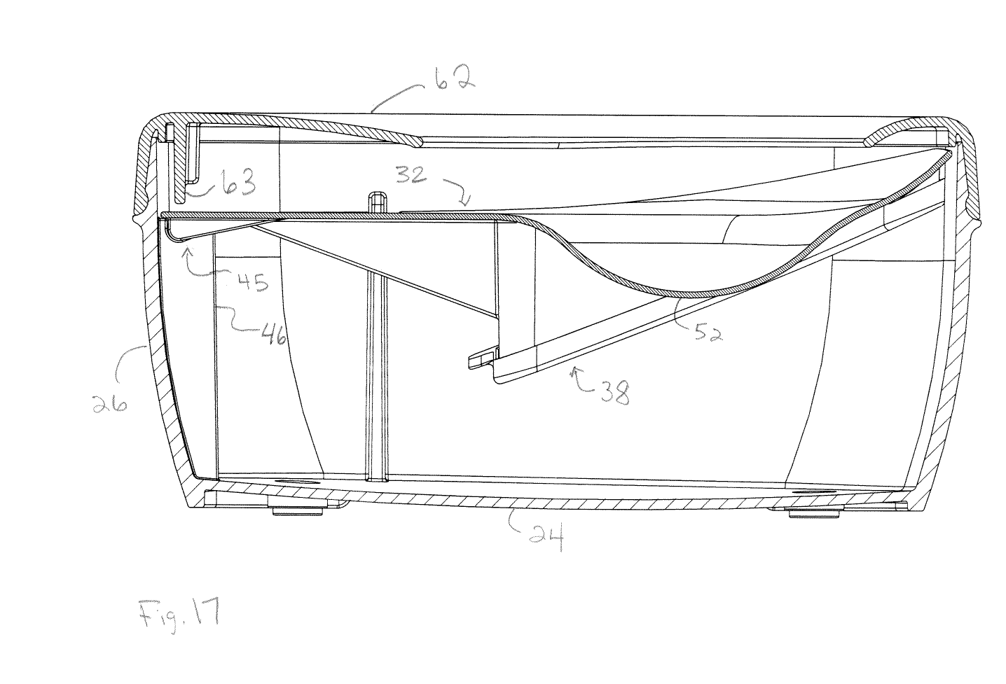

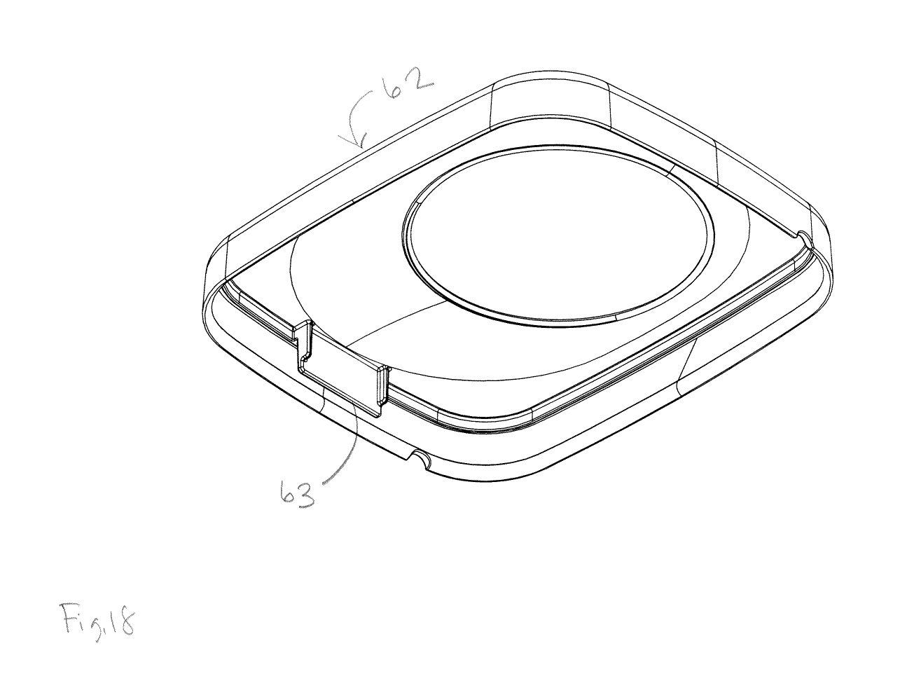

Now referring to FIGS. 1, 3 and 17, the lid 62 of the drinking bowl includes a hinge block 63 that is located over one or more hinge mechanisms 45 of the buoyant member 32 when the lid 62 is in place over the container 22. In this embodiment, the hinge block 63 keeps the hinge pin 48 in place within the cradle 50 of the hinge support 46 by physically blocking the hinge pin 48 from coming out of the cradle 50. In FIG. 18, the hinge block 63 is shown on the underside of the lid 62. In addition, as shown in FIG. 1, lid 62 has a notch 67 that fits over a knob 69 to orient the lid 62 and the container 22. Another knob-and-notch combination 71 is shown in FIG. 14.

The container 22, buoyant member 32 (except for the float base 58), and mounting bracket plates 74, 76, 78, 126 and 128 are preferably made of polypropylene, and the float base 58 and lid 62 are preferably made of polyethylene. However, these components can be made of other polymeric materials and of metals such as aluminum so long as the components function as described herein.

Although a drinking bowl for an animal transporter is shown in the figures, the drinking bowl can be larger or smaller depending upon the size and species of the animal. Thus, the drinking bowl can be any size so long as the buoyant member can move in a pivoting manner in relation to the liquid level. Similarly, a mounting bracket for the drinking bowl can be of any size capable of supporting the drinking bowl when filled to full capacity, and capable of attaching to a support, such as a tubular frame member or wire-mesh door of an animal transporter. In these embodiments, the drinking bowl can provide up to or more than a 12-hour supply of water or another liquid. In addition, while a drinking bowl with a mounting bracket is described, it is understood that the drinking bowl can be used alone without the mounting bracket. Thus, the drinking bowl can be placed on the floor or in the trunk of an automobile, for example, or in a soft-sided animal transporter without a tubular frame, and still provide for reduced spilling and/or splashing of liquid. Also, the drinking bowl can be placed on a stable surface, such as a floor, where spilling and splashing are of less concern. Further, while drinking bowls for dogs and similarly sized animals are described in the various embodiments, it should be understood that drinking bowls for smaller animals, such as mice, rabbits, hamsters and the like, and larger animals, such as horses, cattle and the like, are also provided.

Although the present invention and its advantages have been described in detail, it should be understood that various changes, substitutions and alterations can be made herein without departing from the spirit and scope of the invention. Moreover, the scope of the present application is not intended to be limited to the particular embodiments of the process, manufacture, composition of matter, means, methods and/or steps described in the specification. As one of ordinary skill in the art will readily appreciate from the disclosure of the present invention, processes, manufacture, compositions of matter, means, methods, or steps, presently existing or later to be developed that perform substantially the same function or achieve substantially the same result as the corresponding embodiments described herein may be utilized according to the present invention. Accordingly, the invention is intended to include within its scope such processes, manufacture, compositions of matter, means, methods, or steps.

What is claimed is:

1. A drinking bowl, comprising:
a) a container for holding liquid, the container comprising a closed bottom, a sidewall connected to the closed bottom, and an open top defined by the sidewall; and
b) a buoyant member disposed within the container for covering liquid held therewithin, the buoyant member being hingedly connected to the sidewall and moveable, when liquid is in the container, between a position of floating in liquid and a position of resting on the container bottom, wherein the buoyant member has at least one opening for access to liquid in the container.

2. The drinking bowl of claim 1, wherein the buoyant member comprises a surface portion for covering liquid and a float portion for buoyancy in liquid.

3. The drinking bowl of claim 2, wherein the float portion comprises at least one float element providing buoyancy.

4. The drinking bowl of claim 1, wherein the buoyant member is hingedly connected to the sidewall by at least one hinge mechanism.

5. The drinking bowl of claim 4, wherein the at least one hinge mechanism comprises a hinge pin resting in a cradle.

6. The drinking bowl of claim 1, wherein the surface portion is configured so that the at least one opening is below liquid level when the buoyant member is floating in the liquid and when the buoyant member is resting on the container bottom.

7. The drinking bowl of claim 1, wherein the surface portion is configured so that the at least one opening is above liquid level when the buoyant member is floating in the liquid, the buoyant member being pushed into the liquid to obtain a drink.

8. The drinking bowl of claim 1, further comprising a lid for reversibly covering the drinking bowl, the lid having at least one opening providing access to liquid in the container.

9. The drinking bowl of claim 1, wherein the buoyant member is hingedly connected to the sidewall by at least one hinge mechanism comprising a hinge pin resting in a cradle, and the surface portion is configured so that the at least one opening is either above or below liquid level when the buoyant member is floating in the liquid and when the buoyant member is resting on the container bottom.

10. A spring-loaded mounting bracket for attaching a drinking bowl to a support, the bracket comprising:
a) a front plate comprising a raised region and an opening;
b) a back plate connected to the front plate in face-to-face orientation;
c) a middle plate sandwiched between the front and back plates for reciprocating movement therebetween, the middle plate comprising a raised region which passes through the front plate opening and aligns with the raised region of the front plate, the raised regions cooperating to form a clamp for holding a support;
d) a spring connected to the middle plate and the front or back plate to provide tension for closing the clamp formed by the raised regions as the middle plate reciprocates between the front and back plates; and
e) means for attaching the bracket to a drinking bowl.

11. The mounting bracket of claim 10, wherein the raised region of the front plate forms a curved end region which cooperates with the raised region of the middle plate to form the clamp for holding a tubular support.

12. The mounting bracket of claim 10, wherein the front and back plates form two opposed channels between the plates, and the middle plate comprises two peripheral edge regions respectively inserted into the two opposed channels for reciprocating movement of the middle plate along the channels.

13. The mounting bracket of claim 10, wherein the middle plate includes a handle for pulling back on the middle plate to open the clamp formed by the raised regions of the front and middle plates.

14. The mounting bracket of claim 10, wherein the attachment means is a pair of opposed rails having extended flanges for attachment to a complementary mechanism of the drinking bowl.

15. The mounting bracket of claim 10, wherein the front and back plates form two opposed channels between the plates, and the middle plate comprises two peripheral edge regions respectively inserted into the two opposed channels for reciprocating movement of the middle plate along the channels, and wherein the raised region of the front plate forms a curved end region which cooperates with the raised region of the middle plate to form the clamp for holding a tubular support.

16. The mounting bracket of claim 10, further comprising a latch on the front plate that prevents unwanted removal of the drinking bowl from the mounting bracket.

17. A retaining clip for attaching a drinking bowl to a support, the retaining clip comprising:
a) a front plate comprising means for attaching the retaining clip to a drinking bowl;
b) a retainer plate connected to the front plate to hold the front plate to a support; and
c) a latch on the front plate that prevents unwanted removal of the drinking bowl from the retaining clip.

18. A drinking bowl assembly, comprising:
a) a drinking bowl that comprises:
i) a container for holding liquid, the container comprising a closed bottom, a sidewall connected to the closed bottom, and an open top defined by the sidewall; and
ii) a buoyant member disposed within the container for covering liquid held therewithin, the buoyant member being hingedly connected to the sidewall and moveable, when liquid is in the container, between a position of floating in liquid and a position of resting on the container bottom, wherein the buoyant member has at least one opening for access to liquid in the container; and
b) a mounting bracket for attaching the drinking bowl to a support.

19. The drinking bowl assembly of claim 18, wherein the mounting bracket is a spring-loaded clamping assembly.

20. The drinking bowl assembly of claim 18, wherein the mounting bracket is a retaining clip.
